(19) United States
(12) Patent Application Publication
(10) Pub. No.: US 2024/0372352 A1
(43) Pub. Date: Nov. 7, 2024

(54) METAL TO METAL ENCAPSULATED ELECTRICAL POWER CABLE SYSTEM FOR ESP AND OTHER APPLICATIONS

(71) Applicant: BIM2M-ESP LIMITED [GB], Glasgow (GB)

(72) Inventor: Philip HEAD, Berkshire (GB)

(21) Appl. No.: 18/688,725

(22) PCT Filed: Sep. 6, 2022
(86) PCT No.: PCT/GB2022/052259

§ 371 Date: Mar. 1, 2024

(30) Foreign Application Priority Data
Sep. 6, 2021 (GB) 2112628.9

(51) Int. Cl. H02G 15/00; E21B 43/12; H02G 15/23; H02G 15/24; H02G 15/30

(52) U.S. Cl. CPC H02G 15/003; E21B 43/128; H02G 15/23; H02G 15/24; H02G 15/30

(57) ABSTRACT

1. A pre-assembled cable assembly for a penetrator body or pothead comprises at least one cable located in a volume of the penetrator body or pothead, the volume around the cable being encapsulated in a low temperature alloy. The cable or cables may include a spliced electrical connection located a volume of the penetrator body or pothead such that the volume around the spliced electrical connection being encapsulated in a low temperature alloy.

An Electrical Submersible Pumping (ESP) system is an artificial-lift system that utilizes a downhole pumping system that is electrically driven.

The pump typically comprises several staged centrifugal pump sections that can be specifically configured to suit the production and wellbore characteristics of a given application.

Electrical submersible pump systems are a common artificial-lift method, providing flexibility over a range of sizes and output flow capacities.

A particular weakness of existing systems is that the power cable has to pass through several barriers, which results in a bulkhead and connectors, commonly called a penetrator which are either side of the bulkhead.

The barrier could be the wellhead, a downhole packer or the connection to the motor itself commonly called the pot head, it could also include changing from a round cable to a flat cable called a motor lead extension.

Inside an oil well, the pressures and temperatures can be very high, in addition, gases are vented and can penetrate the jacket of the power cable and migrate to the connector itself.

Saudi Aramco have identified for them that they can attribute 69% of there failures to the power cable system. (Ref: SAUDI ARAMCO JOURNAL OF TECHNOLOGY FALL 2016)

It is the purpose of the present invention to ameliorate or eliminate these and other problems of downhole electrical connection.

To this end, the system eliminates all electrical connectors regardless of the number of bulk heads the cable has to pass through, and provide a pre-assembled cable assemblies consisting of a penetrator body with the cable encapsulated in a low temperature alloy such as bismuth.

According to the present invention the cable assemblies are joined by a splice which is encapsulated in a low temperature alloy such as bismuth.

According to a further aspect of the invention the pot head is encapsulated in encapsulated in a low temperature alloy such as bismuth forms part of the body

According to a further aspect of the invention, end fittings seal the splice tube and seal around the cable

According to a further aspect of the invention, a pressure test port can be included into the penetrator to confirm the integrity of the metal-to-metal seal when assembled into the motor

According to a further aspect of the invention lead rings for metal-to-metal seals at tool and cable junctions

According to a further aspect of the invention the lead is energised by a wavey spring

According to a further aspect of the invention the bismuth fills the void space for a wellhead or packer penetrator

According to a further aspect of the invention the bismuth can be remelted to enable disassembly.

According to a further aspect of the invention the splice are pre-prepared with lamella stab in connections

According to a further aspect of the invention the motor connectors are pre-prepared with lamella stab in connections

According to a further aspect of the invention multiple insulation sleeves are used to insulate the lamella

According to a further aspect of the invention, different melting points of bismuth alloys can be selected depending on the anticipated well bore temperature.

According to a further aspect of the invention different alloys can be selected to have different melting points

According to a further aspect of the invention lead can be used as the encapsulant for applications above 270 C which is the melting point of pure bismuth

According to a further aspect of the invention there is provided a spliced metal clad cable assembly inside a splice tube, at least one cable located in a volume of the splice tube, the void between the splice tube and cable being encapsulated in a low temperature alloy.

According to a further aspect of the invention there is provided a metal clad cable for a motor penetrator or pot head, at least one cable located in a passage of the motor penetrator or pot head, the void space of the pot head being encapsulated in a low temperature alloy.

According to a further aspect of the invention there is provided a cable assembly for a wellhead or packer penetrator, at least one cable located in a passage of the wellhead or packer penetrator, the cable and void space of the wellhead or packer penetrator being encapsulated in a low temperature alloy.

The following is a more detailed description of an embodiment according to the invention by reference to the following drawings in which:

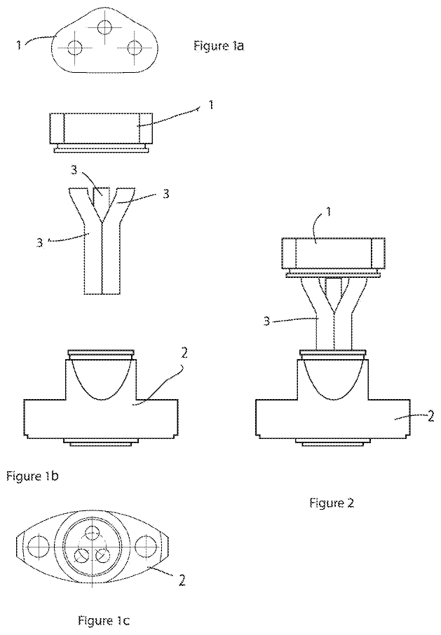

FIG. 1 is a side view of the three metal components which form the pot head

FIG. 2 are the components shown in FIG. 1 assembled

FIG. 3 is a section side view of FIG. 2 with a mould connecting encasing the space between the upper and lower parts

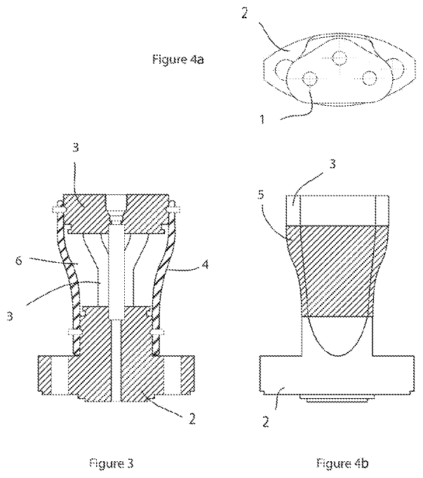

FIG. 4 is a side view of FIG. 3 with the void filled with bismuth and the mould removed, and the pot head is now a solid assembly

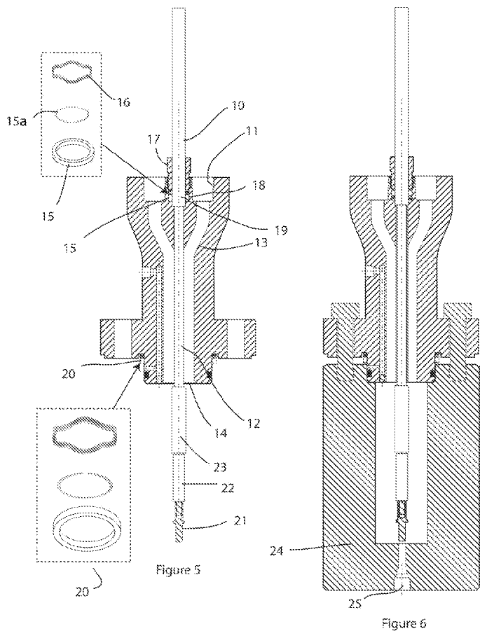

FIG. 5 is a section side view through another embodiment of the pothead with the inclusion of metal to metal seals at the motor-pot head interface, and the metal clad cable and pot head interface

FIG. 6 is a similar view to FIG. 5 with a pressure test adaptor fitted on the lower face to test all the seals prior to shipping to wellsite

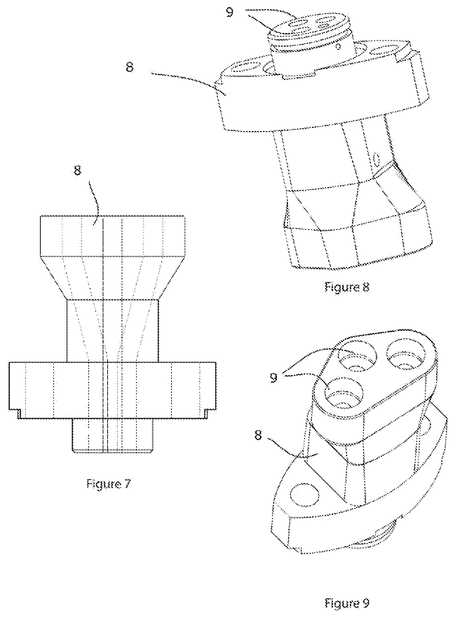

FIG. 7 Is a side view of a single cast pot head

FIG. 8 Is a isometric view of the pot head in FIG. 7, showing the lower face details

FIG. 9 Is a isometric view of the pot head in FIG. 7, showing the upper face details

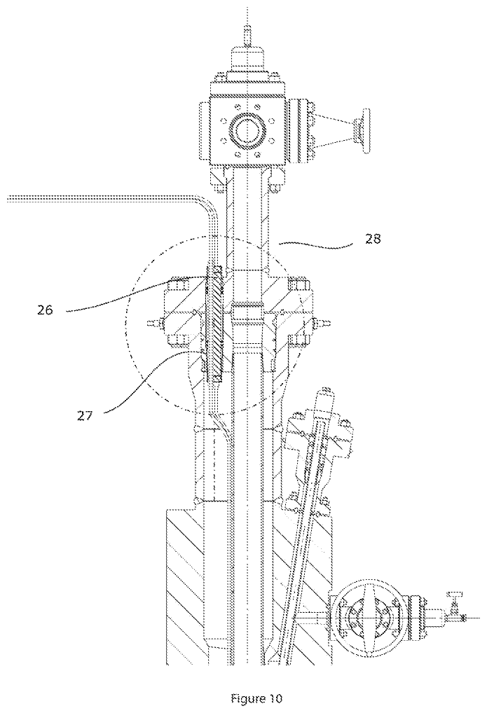

FIG. 10 is a section side view of a wellhead and Christmas tree with the wellhead tri conductor penetrator highlighted, this is also similar to a packer penetrator (not shown)

FIG. 11 is a plan view of the penetrator, with section AA high lighted

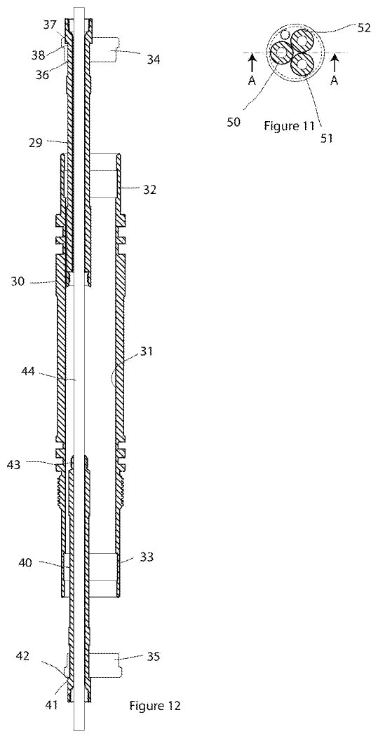

FIG. 12 is a section AA side view of first stage of making the penetrator

FIG. 13 is a plan view of the filled penetrator, section CC

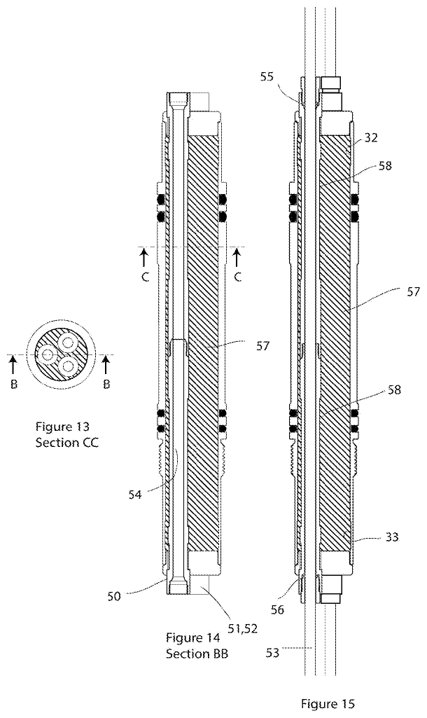

FIG. 14 is a similar view to FIG. 12, and section BB of FIG. 13 with all the internal void spaces filled with bismuth

FIG. 15 is a similar view to FIG. 14 with the metal clad cable passing through the penetrator (wellhead or packer) with metal-to-metal seals at each end of the penetrator

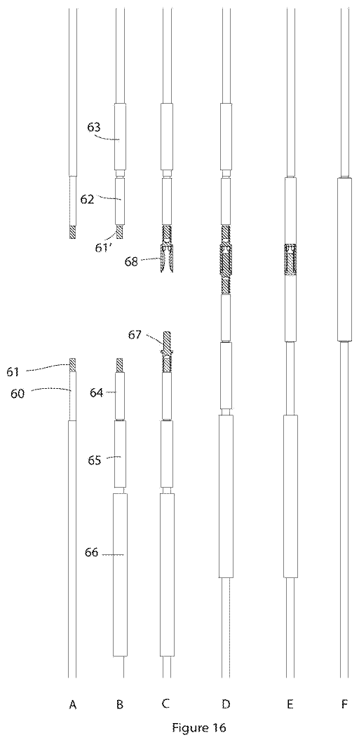

FIG. 16 a,b,c,d,e,f shows the cable preparation, the fitting of different diameter insulation sleeves the attachment of a lamella and finished position of all the insulation sleeves

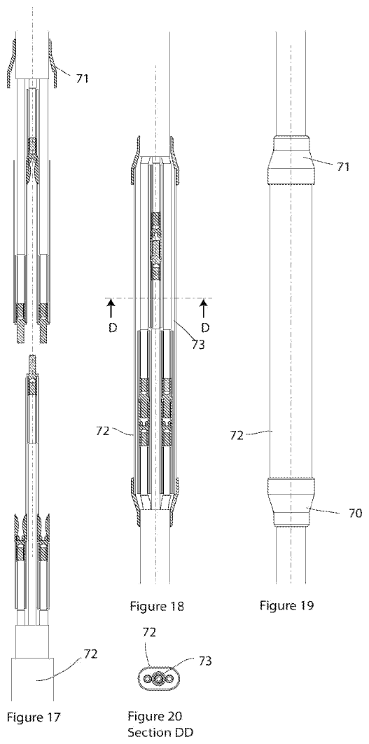

FIG. 17 is a partial section side view of two cables to be joined and insulated

FIG. 18 is the two cable sets shown in FIG. 17 connected, insulated and installed in a steel tube with end fittings, the void space to be filled with bismuth

FIG. 19 is an external view of the assembly shown in FIG. 18

FIG. 20 is a section side view DD of FIG. 18

Referring to FIGS. 1 to 4 there is shown a total of 5 parts, an upper manifold 1 a lower manifold 2 and three tubes 3, in both the upper and lower manifolds there are counter sunk holes to receive the three tubes 3. When the tubes are fitted, there is a continuous path from the upper manifold to the bottom of the lower manifold via each of the three tubes and matching holes in the upper and lower manifolds. A disposable mould 4 is fitted to the upper and lower manifolds and the void space 6 it encases, is filled with bismuth 5 or other low temperature alloy. The end result is a solid metal pot head with precise passages for conductors to pass from outside the motor to inside the motor.

FIGS. 5 and 6 show a metal clad conductor 10 terminating in the upper manifold fitting 11, with the metal jacket removed, the conductor 12 can be fed into the curved passage 13 to exit the bottom of the pot head 14. The seal around the metal jacket and the upper fitting consists of a lead washer 15 (and optionally a circlip 15a) and a wavey spring 16, when the fitting nut 17 is screwed tight the lead washer forms a metal-to-metal seal around the metal clad cable 19 and inside the bore 18 in the upper manifold. The wavey spring energises the lead in the event of any changes in the loading of the lead due creep, vibrations, or changes in temperature during its cycle life

A similar seal assembly 20 is used at the motor-pot head interface

The electrical conductor is terminated with a lamella 21 to enable quick and reliable connection to the motor cable. Insulation sleeves 22,23 are used to provide consistent electrical insulation properties, and again to provide speedy assembly.

While at the factory the assembly can be quality checked, by fitting a pressure test adaptor 24, and applying hydraulic pressure to the port 25 all seals can be pressure tested and the integrity of the pot head verified before being shipped to the wellsite

Referring to FIGS. 7 to 9 there is shown a further embodiment of the assembly, with the pothead cast as a single piece 6, with the curved passages 9 for the cables precast in the casting, this requires a more elaborate casting technique, and high volumes of manufacture to justify the set-up and tooling costs.

Referring to FIGS. 10 to 15 there is shown a tri conductor wellhead or packer penetrator 26 passing through a conventional penetrator body 27. This is important as most Christmas trees 28 and packers are manufactured to accommodate a single round penetrator.

The penetrator housing 30 has the identical profile with o ring grooves etc, as a conventional penetrator. It has a large ID 31 with under cuts 32,33 at the top and bottom. At the top and bottom are end caps 34, 35, in the end caps are three through holes 36 (only one of which is shown in FIG. 12), in the top end cap is installed a tube 29 which shoulders out 37 on a recess 38 in the upper cap. The lower end of the tube has a female thread. In the bottom cap a matching tube 40 is installed and it too has a shoulder 41 which bottoms out of the lower cap 42, the upper end of the tube 40 has a male thread 43. An alignment rod 44 passes though both tubes so as to guide the tubes together during assembly. When the three tube sets 50,51,52 are all tightened together, the void space around the tubes is filled with bismuth 57. Undercut 58 on the tubes and the recesses 32,33 on the large tube act to anchor the parts all together when the bismuth solidifies.

The metal clad conductor 53 can pass through the passage 54 without having to be cut, and metal to metal seal 55,56 at the top and bottom provide a double the pressure barrier.

Referring to FIGS. 16 to 20 is a means of “splicing” a conductor.

100 mm of the outer layer 60 of a conductor is removed (this could be lead or insulation). 20 mm of the inner layer is then removed (this is insulation) to expose the conductor 61. On one side of the conductors to be joined insulation sleeves 62,63 are fitted and on the other side insulation sleeves 64,65,66 are fitted. The male 67 and female 68 of the lamella are soldered or brazed to each conductor 61 and 61′ Then the insulation sleeves are slid over each other to form a multiple stack of known insulation properties and in very rapid time.

FIG. 17 shows two three phase cables which have been factory prepared as described above. At the well site end fittings 70, 71 are slid over the cable and a steel housing 72 slid over one of the three phase cables. The three phases can then be joined as described above very quickly. When all three phases are joined the steel housing 72 can be slid over the joined cables and the end fittings 70, 71 used to seal the ends. The void space around the cables is filled with bismuth 73 providing a impervious/impermeable metal to metal seal protection to the electrical connection.

1. A pre-assembled cable assembly for a penetrator body or pothead, comprising:
at least one cable located in a volume of the penetrator body or pothead;
the volume around the cable being encapsulated in a low temperature alloy.

2. An assembly according to claim 1, wherein the at least one cable includes a spliced electrical connection located a volume of the penetrator body or pothead, the volume around the spliced electrical connection being encapsulated in a low temperature alloy.

3. An assembly according to any previous claim, wherein cable is metal clad.

4. An assembly according to claim 1, wherein penetrator is a motor penetrator.

5. An assembly according to claim 1, wherein penetrator is a wellhead or packer penetrator.

6. An assembly according to claim 1, wherein there is included a tube surrounding the cable, and end fittings which seal the tube and seal around the cable.

7. An assembly according to claim 1, wherein lead rings are included for metal-to-metal seals at tool and cable junctions.

8. An assembly according to claim 7, wherein a wavey spring is included, the lead being energised by the wavey spring.

9. An assembly according to claim 1, wherein the volume is defined by a void space for a wellhead or packer penetrator.

10. An assembly according to claim 2, wherein the electrical connection splice is pre-prepared with lamella stab-in connections on each end of the electrical connection.

11. An assembly according to claim 10, wherein multiple insulation sleeves are used to insulate the lamella.

12. An assembly according to claim 1, wherein the low temperature alloy is bismuth or a bismuth alloy.

13. An assembly according to claim 1, wherein the low temperature alloy is lead.

14. An assembly according to claim 1, wherein the low temperature alloy is selected based on the desired melting point depending on the anticipated well bore temperature.

15. A cable assembly for at least one cable includes a spliced electrical connection, comprising:
at least one spliced cable; and
a splice tube surrounding the at least one spliced cable, defining a volume between the cable and the splice tube;
the volume being encapsulated in a low temperature alloy.

16. An assembly according to claim 15, wherein cable is metal clad.

17. An assembly according to claim 15, wherein there is included end fittings which seal the tube and seal around the cable.

18. An assembly according to claim 15, wherein lead rings are included for metal-to-metal seals at tool and cable junctions.

19. An assembly according to claim 17, wherein a wavey spring is included, the lead being energised by the wavey spring.

20. An assembly according to claim 15, wherein the electrical connection splice is pre-prepared with lamella stab-in connections on each end of the electrical connection.

21. An assembly according to claim 20, wherein multiple insulation sleeves are used to insulate the lamella.

22. An assembly according to claim 15, wherein the low temperature alloy is bismuth or a bismuth alloy.

23. An assembly according to claim 15, wherein the low temperature alloy is lead.

24. An assembly according to claim 15, wherein the low temperature alloy is selected based on the desired melting point depending on the anticipated well bore temperature.

25. A method of disassembling a pre-assembled cable assembly for a penetrator body or pothead, the assembly having at least one cable located in a volume of the penetrator body or pothead and the volume around the cable being encapsulated in a low temperature alloy, the method comprising remelting the low temperature alloy.

26. A method of assembling a cable assembly for a penetrator body or pothead, the assembly having at least one cable located in a volume of the penetrator body or pothead and the volume around the cable being encapsulated in a low temperature alloy, the method comprising enclosing the assembly and applying pressurized fluid to the assembly via a pressure test port to confirm the integrity of seal.
